(19) United States
(12) Patent Application Publication
(10) Pub. No.: US 2009/0003257 A1
(43) Pub. Date: Jan. 1, 2009

(54) APRIORI PROACTIVE RETRANSMISSIONS

(75) Inventors: Prachi P. Kumar, Schaumburg, IL (US); Yuda Y. Luz, Buffalo Grove, IL (US); Mark J. Marsan, Elmhurst, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/769,257

(22) Filed: Jun. 27, 2007

(51) Int. Cl. H04Q 7/00

(52) U.S. Cl. 370/314

(57) ABSTRACT

A method, information processing system, and wireless communication system schedules transmission of data packets in a wireless communication network. At least one selected data packet to be retransmitted to at least one respective receiver (108) is identified. At least one respective selected data packet is scheduled for retransmission (620) in a set of available transmission slots to at least one respective receiver (108). The scheduling is performed prior to determining a failure of a previous communication of the selected data packet and in response to the identifying.

### FIELD OF THE INVENTION

The present invention generally relates to the field of wireless communications, and more particularly relates to scheduling retransmission of data in a wireless communication network.

### BACKGROUND OF THE INVENTION

Retransmission of data to improve communications reliability involves trading off various costs. Costs associated with retransmissions include decreased throughput of a link and increased system latencies. These costs are weighed against the requirement to reliably communicate the data over the wireless link. Wireless systems such as 802.16e systems that have high throughput requirements are especially susceptible to the costs associated with retransmission. End users, in many instances, can notice the decreased throughput and increased system latencies associated with retransmissions.

One method of decreasing the likelihood of retransmissions is to select robust Modulation and Coding Schemes or to increase repetitions of the transmitted data. For example, in 802.16d/e systems, the repetition rate of a transmission can be increased to 2, 4, or 6 times. Often for subscribers at the edge of the cell data sent with 6 repetitions using even the most robust modulation coding scheme is sub-optimal at best. Also, these modulation coding schemes may still require retransmission of data due to dynamic changes in the subscriber's radio environment.

Therefore a need exists to overcome the problems with the prior art as discussed above.

### SUMMARY OF THE INVENTION

Briefly, in accordance with the present invention, disclosed are a method, information processing system, and wireless communication system for scheduling transmission of data packets in a wireless communication network. The method includes identifying at least one selected data packet to be retransmitted to at least one respective receiver. At least one respective selected data packet is scheduled for retransmission in a set of available transmission slots to at least one respective receiver. The scheduling is performed prior to determining a failure of a previous communication of the selected data packet and in response to the identifying.

In another embodiment, an information processing system for scheduling transmission of data packets in a wireless communication network is disclosed. The information processing system includes a memory and a processor that is communicatively coupled to the memory. The information processing system also includes a data packet retransmission scheduler that is communicatively coupled to the memory and the processor. The data packet retransmission scheduler is adapted to identify at least one selected data packet to be retransmitted to at least one respective receiver. At least one respective selected data packet is scheduled for retransmission in a set of available transmission slots to at least one respective receiver. The scheduling is performed prior to determining a failure of a previous communication of the selected data packet and in response to the identifying.

In yet another embodiment, a wireless communication system for scheduling transmission of data packets in a wireless communication network is disclosed. The wireless communication system includes a plurality of base stations and a plurality of wireless device. Each wireless device in the plurality of wireless devices is communicatively coupled to a base station in the plurality of base stations. The wireless communication system also includes at least one information processing system that is communicatively coupled to at least one base station in the plurality of base stations. The information processing system includes a memory and a processor that is communicatively coupled to the memory. The information processing system also includes a data packet retransmission scheduler that is communicatively coupled to the memory and the processor. The data packet retransmission scheduler is adapted to identify at least one selected data packet to be retransmitted to at least one respective receiver. At least one respective selected data packet is scheduled for retransmission in a set of available transmission slots to at least one respective receiver. The scheduling is performed prior to determining a failure of a previous communication of the selected data packet and in response to the identifying.

An advantage of the foregoing embodiments of the present invention that retransmissions of data can be scheduled within the same frame as the original or previous transmission of the data. One embodiment uses link layer protocol processing to automatically combine the multiple copies of the retransmitted data at the receiver to more efficiently improve communications reliability. The retransmissions can also be scheduled in subsequent frames as well. This rescheduling of data transmissions increases the reconstruction of the transmitted data at the receiver. Additionally, various embodiments of the present invention increase the throughput of a link; decrease the time needed for successful reception at the receiver side; and reduce the Frame Erasure Rate.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communication system, according to an embodiment of the present invention;

FIG. 2 is a block diagram illustrating one example of an Access Frame according to an embodiment of the present invention;

FIG. 3 is a block diagram providing an illustrative example of scheduling retransmissions of data according to an embodiment of the present invention;

FIG. 4 is a block diagram illustrating a detailed view wireless device according to an embodiment of the present invention;

FIG. 5 is a block diagram illustrating a detailed view of a site controller according to an embodiment of the present invention;

FIG. 6 is an operational flow diagram illustrating a process of a scheduler scheduling retransmission of data for downlink communications according to an embodiment of the present invention; and

FIG. 7 is an operational flow diagram illustrating a process of a scheduler scheduling retransmission of data for uplink communications according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Wireless Communication System

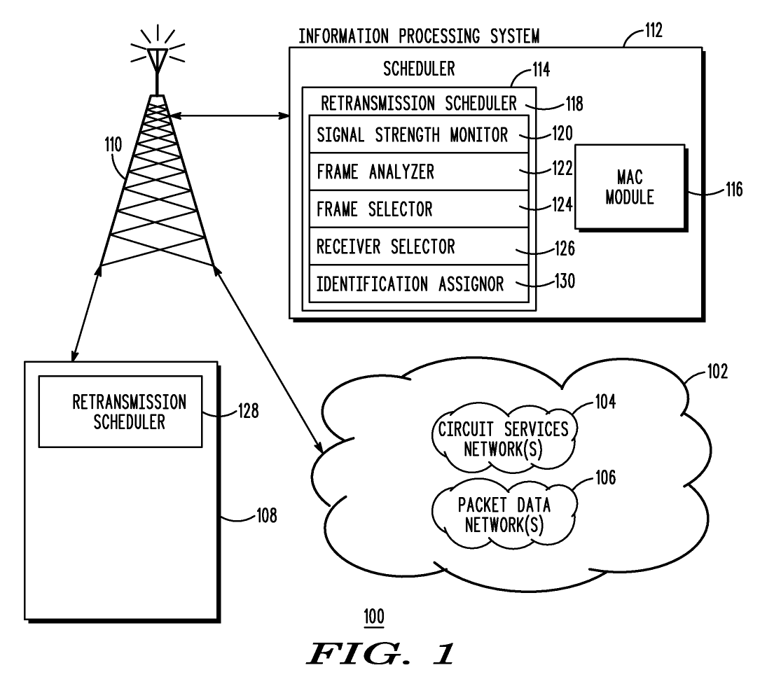

According to an embodiment of the present invention as shown in FIG. 1 a wireless communication system 100 is illustrated. FIG. 1 shows a wireless communication network 102 comprising one or more access networks such as a circuit services network 104 and/or a packet data network 106. In one embodiment, the packet data network 106 is able to include IP or SIP based connectivity networks, which are able to provide data connections at much higher transfer rates then a traditional circuit services network. A packet data network 106 can also include an Evolution Data Only (“EV-DO”) network, a General Packet Radio Service (“GPRS”) network, a Universal Mobile Telecommunications System (“UMTS”) network, an 802.11 network, an 802.16 (WiMax) network, Ethernet connectivity, packet switched dial-up modem connectivity, or the like. A circuit services network 104 provides, among other things, voice services to wireless devices, such as wireless device 108. It should be noted that access networks 104, 106 also include additional components (not shown) such as controllers, transport/interconnect gear, network management modules, and the like that should be known to those of ordinary skill in the art.

Although throughout this discussion one embodiment of the present invention is discussed with respect to an 802.16d/e system, further embodiments of the present invention are not limited to such a system. For example, the communications standard of the access networks 104, 106 can comprise Code Division Multiple Access (“CDMA”), Time Division Multiple Access (“TDMA”), Global System for Mobile Communications (“GSM”), General Packet Radio Service (“GPRS”), Frequency Division Multiple Access (“FDMA”), other IEEE 802.16 standards, Orthogonal Frequency Division Multiplexing (“OFDM”), Orthogonal Frequency Division Multiple Access (“OFDMA”), Wireless LAN (“WLAN”), WiMax or the like. Other applicable communications standards include those used for Public Safety Communication Networks including TErrestrial TRunked Radio (“TETRA”).

The wireless communication system 100 supports any number of wireless devices 108 which can be single mode or multi-mode devices. Multi-mode devices are capable of communicating over multiple types of access networks that include different technologies. For example, one such multi-mode device is able to communicate over the access networks 104, 106 using various services such as Push-To-Talk (“PTT”), Push-To-Talk Over Cellular (“PoC”), multimedia messaging, web browsing, VoIP, multimedia streaming, and the like. The wireless device 108 includes a retransmission scheduler 128 for scheduling retransmissions of data based on scheduling information received from a base station 110. The retransmission scheduling is discussed in greater detail below.

The wireless communication system 100 also includes one or more base stations 110 that are communicatively coupled to a site controller 112. The site controller 112, in one embodiment, includes a scheduler 114 for scheduling the transmission/reception of wireless data between wireless devices 108 and the associated base station 110. In one embodiment, the scheduler 114 is communicatively coupled to a Media Access Control (“MAC”) module 116 that manages the input and output of data traffic. The scheduler 114 can be part of MAC 116 function(s) that makes decisions on the coding and modulation of a burst; decides where the burst resides in the data frame; and form the Downlink-MAP (“DL-MAP”) and Uplink-MAP (“UL-MAP”) of the data frame.

The scheduler 114, in one embodiment, comprises a retransmission scheduler 118 for proactively scheduling retransmissions of data. Stated differently, the retransmission scheduler 118 schedules data to be retransmitted prior to a receiver device indicating that a transmission was not received or that a transmission was corrupted. The retransmission scheduler 118 comprises a signal strength monitor 120, frame analyzer 122, frame selector 124, a receiver selector 126, and an identification assignor 130. The identification assignor 130 assigns an ARQ Channel ID (“ACID”) and an ARQ Identifier Sequence Number (“AISN”) to a data packet. Although shown residing within the scheduler 114, the retransmission scheduler 118 or one or more of its components are able to reside separately from the scheduler 114. The retransmission scheduling process and the retransmission scheduler 118 are discussed in greater detail below.

Apriori Proactive Retransmissions

In one embodiment, the retransmission scheduler 118 schedules the retransmission of particular data in the same frame (uplink or downlink) if unassigned slots exist within that frame. Alternatively, retransmissions can be scheduled in subsequent frames as well. This scheduling of data retransmissions allows increased probability of successful reconstruction of the transmitted data at the receiver. Additionally, one embodiment of the present invention increases the throughput of a link; decreases time needed for successful reception at the receiver side; and reduces Frame Erasure Rate. One embodiment of the present invention is that data can be retransmitted apriori, that is, without determining that a previous transmission of data was not successfully received.

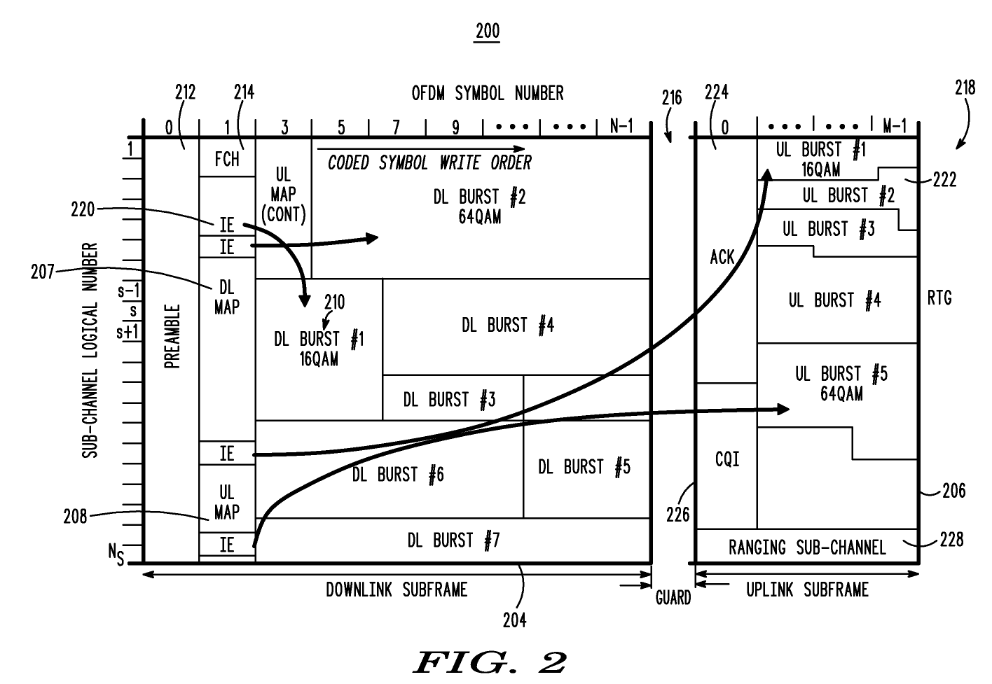

As discussed above, the scheduler 114 schedules the transmission/reception of wireless data between wireless devices 108 and the associated base station 110. FIG. 2 shows an example of an Access frame structure 200 used by the scheduler 114 when scheduling/reception of wireless data between wireless devices 108 and the associated base station 110. The Access frame 200 corresponds to an 802.16d/e system where a downlink sub-frame 204 and an uplink sub-frame 206 have been segmented. The downlink sub-frame 204 has two dimensions, which are time (symbols, e.g. 23 symbols) and frequencies (tones). It should be noted that embodiments of the present invention are not limited to these symbols or a fixed symbol time.

The scheduler 114 can assign a particular wireless device 108 to a symbol and/or tones within the time-frequency space of the downlink sub-frame 204. For example, the base station 110 transmits a downlink map (“DL-MAP”) 207 to each of its wireless devices 108. The wireless devices 108 receive and use the DL-MAP 206 to identify which symbol(s) and frequencies have been assigned to each wireless device 108 for receiving transmitted data from the base station 110. The DL-MAP 206 is used by the wireless device 108 to identify the symbols and tones that that particular device has been assigned. In other words, the DL-MAP 206 identifies when a base station 110 is going to transmit to that particular device. The base station 110 also transmits an uplink map (“UL-MAP”) 208 via the downlink to the wireless devices 108. The downlink, in one embodiment, has 30 sub-channels (uplink can have 35 sub-channels), which are groups of tones.

The UL-MAP 208 identifies to which sub-channel and slots a particular device is assigned and the modulation and coding scheme to be used for each assignment. A slot, in one embodiment, is N tones by M symbols and multiple slots can be allocated to a single burst. This is true for both the uplink and downlink maps. However, the N and M are able to be different for downlink and uplink.

The downlink sub-frame 204 of the Access frame 200 also includes a plurality of downlink bursts such as DL Burst #1 210. Each DL burst, such as DL Burst #1 210, is associated with a single wireless device 108. The downlink sub-frame 204 also includes a preamble 212 and a frame control header (“FCH”) 214, which allows a wireless device 108 to determine downlink timing (with an error related to propagation time) and understand other basic aspects of the wireless communication system 100 such as location of uplink ranging. The Access frame 200 also includes a transmit turn guard (“TTG”) portion 216, and a receive turn guard (“RTG”) portion 218. The transmit turn guard 216 is a time period where the wireless device 108 is transitioning from a receiving mode to a transmitting mode. In other words, the wireless device 108 stops receiving so that it can transmit data from the base station 110. The receive turn guard 218 is a time period where the wireless device 108 is transitioning from a transmitting mode to a receiving mode.

The downlink sub-frame 204 also includes one or more information elements (“IEs”) 220. UL IEs 221 appear in the UL-MAP 208 and DL IEs 220 appear in the DL-MAP 206. Both the DL-MAP 206 and the UL-MAP 208 are generated by the base station. DL IEs 220 in DL-MAP 206 indicate which wireless device 108 receives data in a particular section of the DL frame. DL IEs 220 also indicate whether data being received by a wireless device is a new transmission or retransmission. UL IEs 221 in the UL-MAP 208 indicate which wireless devices 108 transmit data in a particular section of the UL frame. UL IEs 221 also indicate if the data being transmitted is to be a new transmission or a retransmission.

A DL IE 220 in the DL-MAP 206 points to a DL burst 210 and a UL IE 221 in the UL-MAP 208 points to a UL-burst 222. IEs 220, 221 are used to point to particular traffic data burst within the data frame with necessary control information. Each of the IEs 220, 221 include a Connection ID that points to a particular wireless device; time slot location in the sub-frame to tell where the data burst is within the two dimension frame (e.g., IEs specify what symbol/sub-channel starts the time slot allocation plus the number of symbols and number of sub-channels that make up the size of the allocation); and other control information such as coding and modulation form for the data burst, power information of that particular data burst, and the like.

The uplink sub-frame 206 of the Access frame 200 includes acknowledgement information 224, CQI information 226, and UL bursts such as UL burst 222. The CQI information 224 includes signal reception quality information and allows for the scheduler 114 to select a suitable modulation and FEC coding rate for transmission based upon the signal quality received from that particular device. The CQI 224 is transmitted by a wireless device 108 to the base station 110 and reflects the received Signal-To-Interference (plus)-Noise Ratio (“SINR”) of the signal received by that wireless device 108 from that base station 110. Each UL burst, such as UL burst 222, is generally associated with a single wireless device. As can be seen from FIG. 2 the Access frame 200 can include a plurality of DL bursts 210 each associated with a different wireless device and a plurality of uplink bursts 222 each associated with a different wireless device. The uplink sub-frame 208 of the Access frame 200 also includes a ranging channel 228, which allows the base station 110 to determine how far a wireless device 108 is from the base station 110. For example, as wireless devices 108 enter a wireless communication cell they are synchronized with a respective base station 110 in that cell.

With respect to downlink retransmission, the scheduler 114, in one embodiment, via the frame analyzer 122 monitors data from a given number of previous frames 200. Stated differently, the scheduler 114 stores data transmitted in a given number of previous frames 200. This allows the retransmission scheduler 118 to schedule retransmissions of the data. The scheduler 114 schedules its associated wireless devices 108 for receiving data from the base station 110. Once the wireless devices 108 have been scheduled for receiving data from the base station 110, the retransmission scheduler 118 via the frame analyzer 122 determines if any slots within a current frame are unassigned. Alternatively, the frame analyzer 122 can analyze one or more subsequent frames to determine if enough bandwidth exists for retransmitting data within the frame.

If unassigned slots are available within the current frame (or subsequent frames) one or more of these slots can be selected via the frame selector 124 to retransmit data. In one embodiment, the current frame is able to contain data that is being transmitted in the current frame or include retransmission of data from a previously transmitted frame prior to receiving an indication of failed transmission for that data. Once the unassigned slots are selected, the signal strength monitor 118 analyzes signal information associated with each wireless device 108 to identify the wireless device 108 that is to have its data retransmitted in the same or nearby frame. In some instances, the data addressed to wireless devices 108 that are associated with either the strongest signals or the weakest signals are selected to have their data retransmitted.

One embodiment of the present invention selects data for retransmission that is addressed to wireless devices that report received signal quality that is below a given threshold. If no wireless devices report a signal quality below that given threshold, then data that is transmitted to the wireless device with the strongest signal quality is retransmitted. Retransmission of data to a wireless device with the strongest signal quality is performed in this case because such a device will have data transmissions encoded with a low error correction coding gain and may be more susceptible to transmission errors than weaker signals that are encoded with more robust encoding parameters.

In one embodiment, the signal quality indicator received from wireless devices is compared against the given threshold. If the signal quality indicator for all of the wireless devices is above that given threshold, then the wireless device 108 that is associated with the strongest signal is selected by the receiver selector 126 for data retransmission. If one or more wireless devices report their signal quality is below the given threshold, then one or more of the wireless devices 108 associated with the weakest signal is selected by the receiver selector 126.

The one or more selected wireless devices 108 are the devices that are to have their data retransmitted prior to receiving an indication of transmission success or failure. Stated differently, the data transmitted to the selected wireless device 108 is to be retransmitted to the wireless device 108. In one embodiment, the retransmission scheduler 118 determines if the selected wireless device 108 is able to use a Hybrid Automatic Repeat reQuest (“HARQ”) protocol to receive and process communicated data. HARQ enabled receivers are able to store incorrectly received data packets that are integrated into the interpretation of subsequently received retransmissions of that same data packet. Some other protocols, such as ARQ protocols, discard incorrectly received data. When a retransmission of that data is received by a HARQ enabled receiver, the incorrect data and retransmitted data can be combined to improve message decoding and increase the likelihood of successful data reception.

If the selected wireless device 108 is not HARQ capable, the processing of one embodiment removes that wireless device 108 from the list of devices for retransmission. In such a case, the wireless device 108 with either the next weakest or strongest (depending on the threshold comparison result above) is then selected until a HARQ capable device is identified. Once a HARQ device is identified, the retransmission scheduler 118 analyzes the original transmission of data to the selected device to determine if the original transmission used HARQ. If the original transmission did not use HARQ then this device 108 is removed from the list of devices for retransmission and the transmission associated with the next selected device is analyzed. If the original transmission of data did use HARQ, the data is retransmitted to the selected device using the selected unassigned slots. The selected wireless device 108 is then removed from the list of devices for retransmission and the above process is repeated for the next selected wireless device 108.

With respect to uplink retransmission, the retransmission scheduler 118 at the site controller 114 of the base station 110 schedules retransmissions of data from a wireless device 108 to the base station 110. The retransmission scheduler 118, in one embodiment, further selects a wireless device 108 to perform retransmission based on comparing received signal strengths at the base station 110 for each wireless device 108 to a signal threshold, in a manner similar to that described above. However, the selected wireless device 108 does not necessarily have to be HARQ capable because integration of previously received data packets during packet decoding is not performed at the wireless device 108 for uplink retransmissions. The combining is performed at the receiver, which is the base station 110 during uplink communications.

The retransmission scheduler 118 that is located in the base station 110 of one embodiment selects one or more unassigned slots as discussed above for scheduling the retransmission of data from a wireless device 108 during the uplink sub-frame. However, the retransmission scheduler 118 notifies the selected wireless device 108 of the data to retransmit and when to retransmit the data. The base station 110 identifies the data to be retransmitted in both UL and DL transmissions. This information is placed within the UL-MAP 210 that is transmitted to the selected wireless device 108. One embodiment implements retransmissions for both the downlink and the uplink that use the same ARQ Channel ID (“ACID”) and ARQ Identifier Sequence Number (“AISN”) as was used in the original transmission of the data packet.

An alternative method for retransmitting data is for the retransmission scheduler 118 to select a more robust Modulation and Coding Scheme (“MCS”). In this embodiment, the retransmission scheduler 118 identifies wireless devices 108 associated with signal strengths below a given threshold as discussed above. Also, the retransmission scheduler 118 can also identify the wireless devices 108 that are associated with an MCS that is identified as not being the most robust MCS. In such embodiments, the retransmission scheduler 118 determines if unassigned slots exist, which indicates that extra bandwidth exists within the current frame, for retransmitting data. If unassigned slots do exist, the retransmission scheduler 118 selects one or more of these unassigned slots as a time duration to retransmit data to the selected device using a more robust MCS than was used for the original data transmission. Therefore, the scheduler 114 at the base station 110 also achieves proactive retransmissions, which appear to be a new transmission to the wireless device 108. The scheduler 114 at the base station 110, in this manner, takes advantage of the Incremental Redundancy HARQ combining capability at the device 108 to perform apriori retransmissions proactively without waiting for HARQ ACK/NAK feedback.

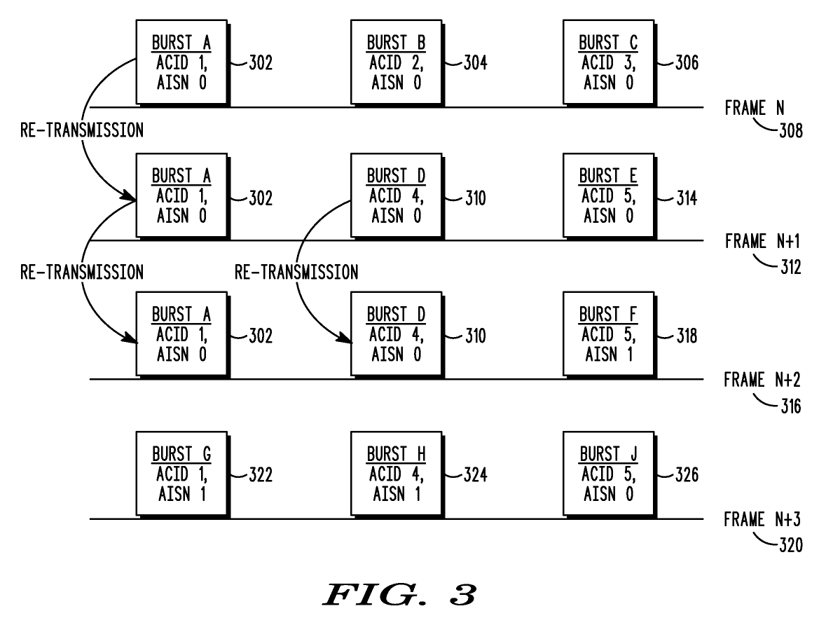

The FIG. 3 is an illustrative example of retransmitting data according to an embodiment of the present invention. One HARQ channel transmits one burst over the air at a time. The transmitting HARQ channel, which is uniquely identified by its ACID, becomes available when an AISN bit associated with the HARQ channel is toggled. For example, the scheduler 114 schedules three bursts Burst A 302, Burst B 304, and Burst C 306 within Frame N 308 to be transmitted to a wireless device 108 over the air. Each of these three bursts uses a separate HARQ channel ACID 1, ACID 2, and ACID 3, respectively. These bursts can be represented as Frame N: (Burst A—ACID 1, AISN 0), (Burst B—ACID 2, AISN 0), (Burst C—ACID 3, AISN 0).

The AISN bit indicates to the wireless device 108 that the ACID now carries a re-transmission of a burst that last used the same (ACID, AISN) combination. Therefore, if the base station 110 retransmits Burst A, it uses ACID 1, AISN 0, which was used in the original transmission of Bust A. If the scheduler 114 toggles the AISN bit for an ACID compared to the last time it was used, the wireless device 108 interprets that this ACID is now being assigned to a new Burst D 310. The wireless device 108 learns how the scheduler 114 has assigned the ACID (new burst or retransmission of a burst) by analyzing the MAP entry of the burst, which includes the ACID and AISN for each burst.

Assume that Frame N+1 312 was nearly empty and the retransmission scheduler 118 determines that Burst A 302 is to be retransmitted. Frame N+1 312 can be represented as follows Frame N+1: (Burst A—ACID 1, AISN 0), (Burst D—ACID 4, AISN 0), (Burst E—ACID 5, AISN 0). Notice that ACID 2 and ACID 3 are not being used here to transmit the new bursts, Burst D 310 and Burst E 314, because they are pending ACK/NAK feedback from the receiving device. However, if the scheduler 114 determines that it does not want to wait for ACK/NAK feedback for ACID 2 and ACID 3, it can toggle the AISN bit for ACID 2 and ACID 3 to indicate the new Burst D 310 and Burst E 314. In this example, Frame N+1 312 can be represented as Frame N+1: (Burst A—ACID 1, AISN 0), (Burst D—ACID 1, AISN 1), (Burst E—ACID 2, AISN 1).

In another example, Frame N+2 316 has sufficient unassigned slots for retransmitting data. The retransmission scheduler 118 determines that data associated with an original transmission using ACID 1 and ACID 4 is to be retransmitted. Frame N+2 316 can be represented as follows Frame N+2: (Burst A—ACID 1, AISN 0), (Burst D—ACID 4, AISN 0), (Burst F—ACID 5, AISN 1). Again notice that the ACID, AISN combination does not change since the last transmission to indicate re-transmission on these ACIDs. Frame N+2 also include a new Burst F 318 with ACID 5, AISN 1.

In one embodiment, the retransmission of data is a retransmission of an immediately previous transmission. Once the AISN is toggled for an ACID, the receiving wireless device 108 interprets it as a new burst and delivers the previous burst used by this ACID to higher applications, as further described in standards specification for 802.16-2004 (d-spec) Section 6.3.17, which is hereby incorporated by reference in its entirety. If the AISN bit for ACID 1 is toggled in Frame N+3 320, Frame N+3 320 can be represented as Frame N+3: (Burst G—ACID 1, AISN 1), (Burst H—ACID 4, AISN 1), (Burst J—ACID 5, AISN 0). Burst G 322, Burst H 324, and Burst J 326 are all new bursts. Notice that although frame N+3 320 uses the same ACID, AISN combination as Frame N+1 312 (ACID 5, AISN 0) the AISN bit was toggled twice, two different bursts have been received on ACID 5.

Exemplary Wireless Device

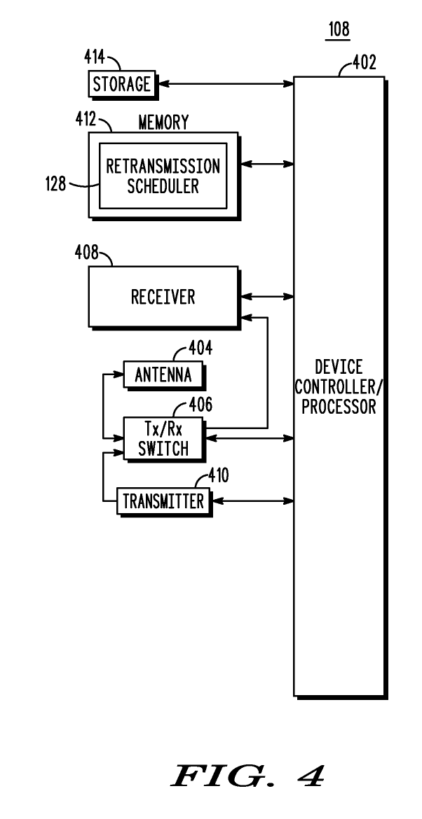

FIG. 4 is a block diagram illustrating a detailed view of the wireless device 108 according to an embodiment of the present invention. It is assumed that the reader is familiar with wireless communication devices. To simplify the present description, only that portion of a wireless communication device that is relevant to the present invention is discussed. The wireless device 108 operates under the control of a device controller/processor 402, that controls the sending and receiving of wireless communication signals. In receive mode, the device controller 402 electrically couples an antenna 404 through a transmit/receive switch 406 to a receiver 408. The receiver 408 decodes the received signals and provides those decoded signals to the device controller 402.

In transmit mode, the device controller 402 electrically couples the antenna 404, through the transmit/receive switch 406, to a transmitter 410. It should be noted that in one embodiment, the receiver 408 and the transmitter 410 are a dual mode receiver and a dual mode transmitter for receiving/transmitting over various access networks providing different air interface types. In another embodiment a separate receiver and transmitter is used for each of type of air interface.

The device controller 402 operates the transmitter and receiver according to instructions stored in the memory 412. These instructions include, for example, a neighbor cell measurement-scheduling algorithm. The memory 412, in one embodiment, includes the retransmission scheduler 128. The wireless device 108, also includes non-volatile storage memory 414 for storing, for example, an application waiting to be executed (not shown) on the wireless device 108.

Exemplary Information Processing System

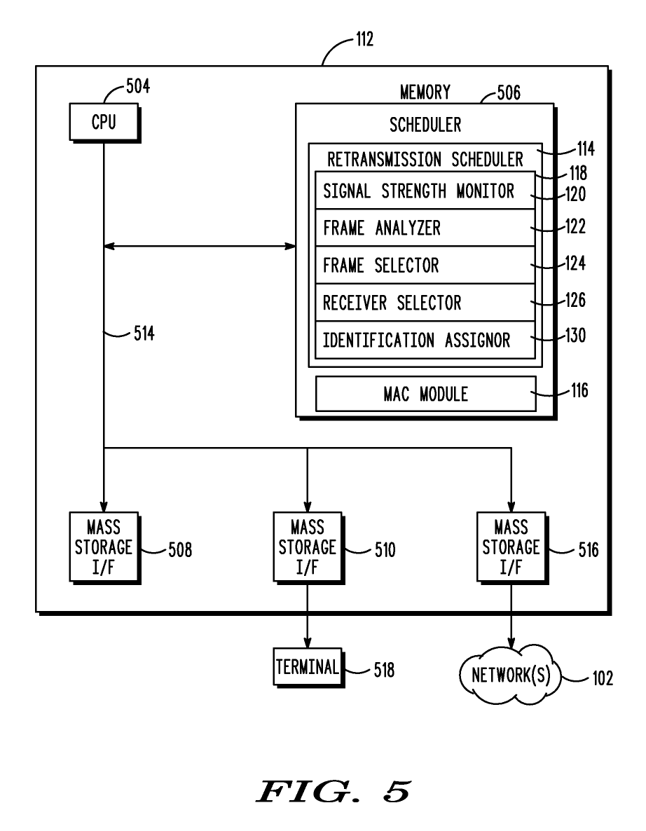

FIG. 5 is a block diagram illustrating a more detailed view of an information processing system 512 such as the site controller 112. The information processing system 512 is based upon a suitably configured processing system adapted to implement the embodiment of the present invention. For example, a personal computer, workstation, or the like, may be used. The information processing system 512 includes a computer 502. The computer 502 has a processor 504 that is connected to a main memory 506, a mass storage interface 508, a man-machine interface 510, and network adapter hardware 516. A system bus 514 interconnects these system components.

The main memory 506 includes at least the scheduler 114 and the MAC module 516. The scheduler 114, as discussed above, comprises the retransmission scheduler 118 including the signal strength monitor 120, frame analyzer 122, frame selector 124, receiver selector 126, and identification assignor 130. The retransmission scheduler 118 identifies at least one selected data packet to be retransmitted to at least one respective receiver. The retransmission scheduler 118 also schedules, prior to determining a failure of a previous communication of the selected data packet and in response to the identifying, at least one respective selected data for retransmission in the available transmission slots to at least one respective receiver. Although illustrated as concurrently resident in the main memory 506, it is clear that respective components of the main memory 506 are not required to be completely resident in the main memory 506 at all times or even at the same time. One or more of these components can be implemented as hardware.

The mass storage interface 508 can store data on a hard-drive or media such as a CD. The Man-machine interface 510 allows technicians, administrators, and the like, to directly connect to the information processing system 512 via a terminal(s) 518.

The network adapter hardware 516 is used to provide an interface to the wireless communication network 102, a public network such as the Internet, and the like. Embodiments of the present invention are able to be adapted to work with any data communications connections including present day analog and/or digital techniques or via a future networking mechanism.

Process Of Rescheduling Transmission For Downlink Communications

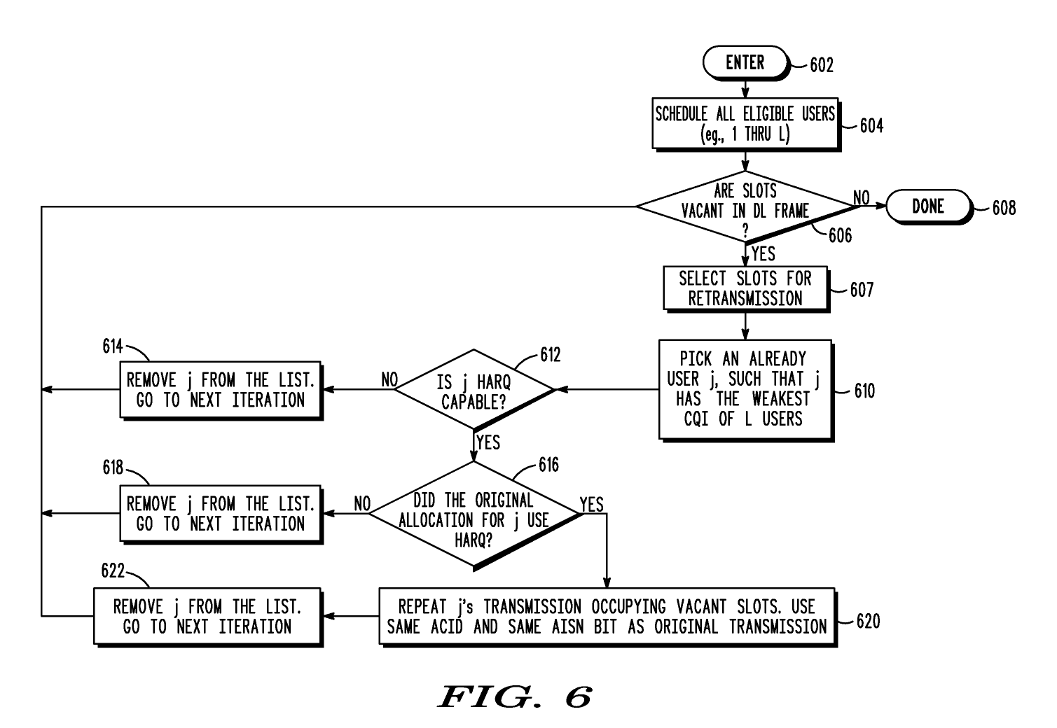

FIG. 6 is an operational flow diagram illustrating a process of a base station rescheduling transmission of data. The operational flow diagram of FIG. 6 begins at step 602 and flows directly to step 604. The scheduler 114, at step 604 schedules its associated wireless devices 108 for receiving data from the base station 110. Once the wireless devices 108 have been scheduled for receiving data from the base station 110, the retransmission scheduler 118, at step 606, via the frame analyzer 122 determines if any slots within a current frame are unassigned.

If the result of the determination at step 606 is negative, the control flow exits at step 608. If the result of the determination at step 606 is positive, one or more of these slots, at step 607, are selected via the frame selector 124 to retransmit data. Once the unassigned slots are selected, the signal strength monitor 118, at step 610, analyzes signal information associated with each wireless device 108 to identify the wireless device 108 associated with the weakest signal. The identified signal, in one embodiment, is compared against a given threshold. If the signal is above the given threshold then the wireless device 108 associated with the strongest signal is selected by the receiver selector 126. If the signal is below the given threshold then the wireless device 108 associated with the weakest signal is selected by the receiver selector 126.

The retransmission scheduler 118, at step 612, determines if the selected wireless device 108 is Hybrid Automatic Repeat request (“HARQ”) capable. If the result of the determination at step 612 is negative, the wireless device, at step 614 is removed from the list of devices for retransmission. The control flow then returns to step 606. The wireless device with either the next weakest or strongest (depending on the threshold comparison result above) is then selected until a HARQ capable device is identified. Once a HARQ device is identified, the retransmission scheduler 118, at step 616, analyzes the original transmission of data to the selected device to determine if the original transmission used HARQ. If result of the determination at step 616 is negative, then this device, at step 618, is removed from the list of devices for retransmission. The control flow then returns to step 606.

If the result of the determination at step 616 is positive, the data, at step 620 is retransmitted to the selected device using the selected unassigned slots. The selected device, at step 622, is removed from the list of devices for retransmission. The control flow returns back to step 606.

Process Of Rescheduling Transmission For Uplink Communications

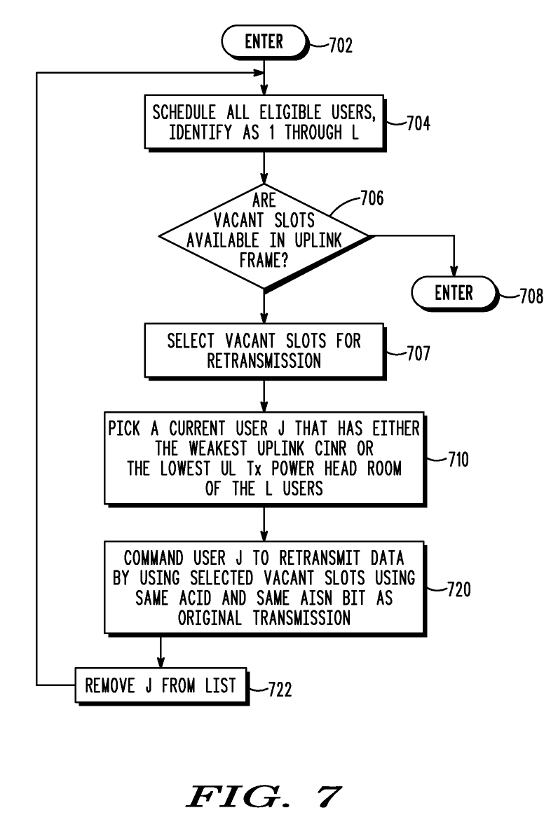

FIG. 7 is an operational flow diagram illustrating a process of a base station rescheduling transmission of data at a wireless device. The operational flow diagram of FIG. 7 begins at step 702 and flows directly to step 704. The scheduler 114, at step 704 schedules its associated wireless devices 108 to transmitting data to the base station 110. Once the wireless devices 108 have been scheduled to transmit data to the base station 110, the retransmission scheduler 118, at step 706, via the frame analyzer 122 determines if any slots within a current frame are unassigned.

If the result of the determination at step 706 is negative, the control flow exits at step 708. If the result of the determination at step 706 is positive, one or more of these slots, at step 707, are selected via the frame selector 124 to retransmit data.

Once the unassigned slots are selected, the signal strength monitor 118, at step 710, analyzes signal information associated with each wireless device 108 to identify the wireless device 108 associated with a signal strength that meets the requirement to retransmit data in a vacant slot. The identified signal, in one embodiment, is compared against a given threshold. If the signal is above the given threshold then the wireless device 108 associated with the strongest signal is selected by the receiver selector 126. If the signal is below the given threshold then the wireless device 108 associated with the weakest signal is selected by the receiver selector 126. The wireless device 108 selected is thus selected to perform retransmissions.

The processing continues with the scheduler 114 commanding, at step 720, the selected device, identified as user J in one embodiment, to retransmit data by using selected vacant slots. In performing this retransmission, the wireless device 108 is commanded to use the same ACID and the same AISN bit as in the original transmission of the data that is now being retransmitted. In one embodiment, the scheduler 114 places the retransmission instructions within the UL-MAP 208 and transmits to the wireless device 108. The wireless device receives the UL-MAP 208 along with the retransmissions instructions from the base station 110. The instructions can indicate what data the wireless device 108 is to retransmit, when to retransmit the data, what slots of what frame to retransmit the data in, and the like. The selected device, at step 722, is removed from the list of devices for retransmission. The control flow returns back to step 706.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for scheduling transmission of data packets in a wireless communication network, the method comprising:
identifying at least one selected data packet to be retransmitted to at least one respective receiver;
scheduling, prior to determining a failure of a previous communication of the selected data packet and in response to the identifying, at least one respective selected data packet for retransmission in a set of available transmission slots to at least one respective receiver.

2. The method of claim 1, further comprising determining that a current transmission frame comprises available transmission slots for retransmitting the data, and wherein the identifying and the scheduling are performed in response to the determining that the current transmission frame comprises available transmission slots.

3. The method of claim 1, further comprising:
receiving, from a base station at a mobile device, an uplink sub-frame definition comprising an indication to retransmit data,
wherein the scheduling is performed in response to the receiving the uplink sub-frame definition comprising the indication to retransmit data.

4. The method of claim 1, wherein the determining a failure of a previous communication of the selected data comprises one of a receipt of a negative acknowledgement, and a timeout to receive a positive acknowledgement.

5. The method of claim 1, wherein the identifying the at least one selected data packet further comprises:
comparing a signal quality indicator associated with a respective receiver in a plurality of receivers to a given threshold;
determining, in response to the comparing, that at least one signal quality indicator is below the given threshold;
selecting, in response to the determining that at least one signal quality indicator is below the given threshold, at least one receiver within the plurality of receivers that is associated with a lowest signal quality indictor; and
identifying, in response to the determining that at least one signal quality indicator is below the given threshold, at least one data packet addressed to the at least one receiver that is associated with the lowest signal quality indicator as the at least one selected data packet.

6. The method of claim 5, wherein the identifying the at least one selected data packet further comprises:
selecting, in response to the determining that at least one signal quality indicator is not below the given threshold, a receiver associated with a highest signal quality indictor; and
identifying, in response to the determining that at least one signal quality indicator is not below the given threshold, at least one data packet addressed to the receiver associated with a highest signal quality indictor as the at least one selected data packet.

7. The method of claim 1, wherein the respective selected data packet is also scheduled for a prior transmission in the current transmission frame.

8. The method of claim 1, wherein the respective selected data packet has been scheduled for transmission in at least one previous transmission frame.

9. The method of claim 1, wherein the identifying at least one selected data packet further comprises:
determining if the at least one respective receiver is Hybrid Automatic Repeat reQuest (HARQ) capable;
identifying, in response to determining that the at least one respective receiver is HARQ capable, the respective receiver to receive the respective retransmission; and
identifying, in response to determining that the at least one respective receiver is not HARQ capable, the at least one selected data packet as a data packet addressed to an HARQ capable receiver.

10. The method of claim 1, wherein the scheduling further comprises:
assigning an Automatic Repeat reQuest Channel ID and Automatic Repeat reQuest Identifier Sequence Number to the at least one selected data packet, wherein the Automatic Repeat reQuest Channel ID and the Automatic Repeat reQuest Identifier Sequence Number were previously assigned to the at least one selected data packet during a previous transmission of the at least one selected data packet.

11. An information processing system for scheduling transmission of data packets in a wireless communication network, the information system comprising:
a memory;
a processor communicatively coupled to the memory;
a data packet retransmission scheduler, communicatively coupled to the memory and the processor, adapted to identify at least one selected data packet to be retransmitted to at least one respective receiver,
the data packet retransmission scheduler further adapted to schedule, prior to determining a failure of a previous communication of the selected data packet and in response to identifying at least one selected data packet, at least one respective selected data packet for retransmission in a set of available transmission slots to at least one respective receiver.

12. The information processing system of claim 11, wherein the data packet retransmission scheduler is further adapted to determine that a current transmission frame comprises available transmission slots for retransmitting the data, and wherein data packet retransmission scheduler identifies and schedules response to determining that the current transmission frame comprises available transmission slots.

13. The information processing system of claim 11 information processing system of claim 11, wherein the data packet retransmission scheduler is further adapted to identify by:
comparing a signal quality indicator associated with a respective receiver in a plurality of receivers to a given threshold;
determining, in response to the comparing, that at least one signal quality indicator is below the given threshold;
selecting, in response to the determining that at least one signal quality indicator is below the given threshold, at least one receiver within the plurality of receivers that is associated with a lowest signal quality indictor; and
identifying, in response to the determining that at least one signal quality indicator is below the given threshold, at least one data packet addressed to the at least one receiver that is associated with the lowest signal quality indicator as the at least one selected data packet.

14. The information processing system of claim 13, wherein the data packet retransmission scheduler is further adapted to identify the at least one selected data packet by:
selecting, in response to the determining that at least one signal quality indicator is not below the given threshold, a receiver associated with a highest signal quality indictor; and
identifying, in response to the determining that at least one signal quality indicator is not below the given threshold, at least one data packet addressed to the receiver associated with a highest signal quality indictor as the at least one selected data packet.

15. The information processing system of claim 11, wherein the respective selected data packet is one of scheduled for a prior transmission in the current transmission frame and scheduled for transmission in at least one previous transmission frame.

16. The information processing system of claim 11, wherein the data packet retransmission scheduler further comprises an identification assignor adapted to:
assign an Automatic Repeat reQuest Channel ID and Automatic Repeat reQuest Identifier Sequence Number to the at least one selected data packet, wherein the Automatic Repeat reQuest Channel ID and the Automatic Repeat reQuest Identifier Sequence Number were previously assigned to the at least one selected data packet during a previous transmission of the at least one selected data packet.

17. A wireless communication system for scheduling transmission of data packets, the wireless communication system comprising:
a plurality of base stations;
a plurality of wireless devices, wherein each wireless device in the plurality of wireless devices is communicatively coupled to a base station in the plurality of base stations; and
at least one information processing system communicatively coupled to at least one base station in the plurality of base stations, wherein the at least one information processing system comprises:
a memory;
a processor communicatively coupled to the memory;
a data packet retransmission scheduler, communicatively coupled to the memory and the processor, adapted to identify at least one selected data packet to be retransmitted to at least one respective receiver, the data packet retransmission scheduler further adapted to schedule, prior to determining a failure of a previous communication of the selected data packet and in response to identifying at least one selected data packet, at least one respective selected data packet for retransmission in a set of available transmission slots to at least one respective receiver.

18. The wireless communication system of claim 17, wherein the data packet retransmission scheduler is further adapted to determine that a current transmission frame comprises available transmission slots for retransmitting the data, and wherein data packet retransmission scheduler identifies and schedules response to determining that the current transmission frame comprises available transmission slots.

19. The wireless communication system of claim 17, wherein the data packet retransmission scheduler is further adapted to identify by:
comparing a signal quality indicator associated with a respective receiver in a plurality of receivers to a given threshold;
determining, in response to the comparing, that at least one signal quality indicator is below the given threshold;
selecting, in response to the determining that at least one signal quality indicator is below the given threshold, at least one receiver within the plurality of receivers that is associated with a lowest signal quality indictor; and
identifying, in response to the determining that at least one signal quality indicator is below the given threshold, at least one data packet addressed to the at least one receiver that is associated with the lowest signal quality indicator as the at least one selected data packet.

20. The wireless communication system of claim 17, wherein the data packet retransmission scheduler further comprises an identification assignor adapted to:
assign an Automatic Repeat reQuest Channel ID and Automatic Repeat reQuest Identifier Sequence Number to the at least one selected data packet, wherein the Automatic Repeat reQuest Channel ID and the Automatic Repeat reQuest Identifier Sequence Number were previously assigned to the at least one selected data packet during a previous transmission of the at least one selected data packet.
